(19) United States
(12) Patent Application Publication
(10) Pub. No.: US 2006/0123887 A1
(43) Pub. Date: Jun. 15, 2006

(54) Apparatus for pressure detection in an engine combustion chamber

(76) Inventor: Yves Dordet, Fonsorbes (FR)

Correspondence Address: YOUNG & THOMPSON, 745 SOUTH 23RD STREET, 2ND FLOOR, ARLINGTON, VA, 22202, US

(21) Appl. No.: 10/538,748

(22) PCT Filed: Dec. 12, 2003
(86) PCT No.: PCT/EP03/14103

§ 371 Date: Dec. 22, 2005

(30) Foreign Application Priority Data
Dec. 20, 2002 (FR) 02/16372

(51) Int. Cl. G01L 23/22

(52) U.S. Cl. 73/35.12; 73/119 R

(57) ABSTRACT

An apparatus for detecting pressure in an engine combustion chamber includes a functional member (1) mounted in an orifice (3) of a cylinder head (5) and a pressure sensor (19) axially pressed against one part (1b) linked to the functional member, via a bearing surface (17) fixed relative to the cylinder head, so as to enable the sensor to detect a displacement of the functional member upon combustion pressure variations. A mechanical link between the functional member and the cylinder head (5) is provided via an additional element (15, 17) fixedly linked to the cylinder head and part at least of the additional element exerts a pressure on the sensor (19) defining the bearing surface in fixed position relative to the cylinder head when the functional member mounted on the cylinder head (5) is in operation ready to be subjected to the pressure in the combustion chamber.

The invention relates to a device for detecting the pressure in a combustion chamber of an internal combustion engine.

The most usual measurement method is to place a dedicated sensor in the combustion chamber. A drilling and a tapping both in addition to those already made in the cylinder head have therefore to be provided. This is not satisfactory given the additional costs generated and the lack of space available in the cylinder head, as current engines are increasingly incorporating a great many large-sized valves. An alternative to this type of installation is therefore needed.

EP-A-1 096 141 already discloses a device comprising:

a functional member used in the operation of the engine, the functional member passing through the wall of a cylinder head inside an orifice having an axis and formed in this wall, the functional member communicating via this orifice with a combustion chamber of the engine and being intended to be mechanically linked to the cylinder head, with part of this functional member being able to move axially with respect to the rest of the functional member secured to the cylinder head under the effect of the pressure in the combustion chamber,

and a sensor sensing the combustion pressure in this chamber, the sensor being axially pressed against a part linked to the functional member, via a bearing surface fixed in terms of position with respect to the cylinder head, independently of the pressure in the combustion chamber, so that the sensor detects the displacement of said part of the functional member upon variations in the combustion pressure in the combustion chamber.

However, measuring the pressure in the combustion chamber in this way entails the presence of a functional member (a glow plug in the case of EP-A-1 096 141) specially designed for the intended purpose. Thus, this functional member comprises an inner core able to move axially with respect to an outer body screwed into the orifice in the cylinder head, under the effect of the combustion pressure, the sensor being interposed between two local regions of the core and of the body, the surface of the latter concerned therefore defining the “bearing surface” introduced hereinabove.

Such a design also dictates mounting characteristics which, for example, oblige the cylinder head manufacturer to tap into the cylinder head at the site of the orifice in which the plug is to be mounted, and to use the body of the sensor as a fixed reference surface for taking pressure readings.

The objects of the invention are:

to dispense with having to drill the cylinder head in order to fit a detection device there,

to provide more practical conditions of attachment of the functional member to the cylinder head,

to limit the cost of the detection device, at least in certain embodiments,

to rationalize the design of this device.

To this end, an important characteristic of this invention anticipates that:

a mechanical link between the functional member and the cylinder head is achieved by way of an additional means linked fixedly to this cylinder head,

and at least part of this additional means exerts pressure on the sensor thereby defining said bearing surface that is fixed in terms of position with respect to the cylinder head when the functional member which is mounted on the cylinder head is in an operational state ready to be subjected to the pressure in the combustion chamber.

An additional problem relates to the way of linking the functional member to the cylinder head without necessarily fixing the former directly to the latter, so as to encourage the use of the aforementioned displacement sensor, including using “monobloc” functional members that have no moving parts, such as spark plugs or injectors.

For that, it is advisable that:

part of the exterior periphery of the functional member intended to come immediately to face the wall of the orifice in the cylinder head is mounted freely inside this orifice, having no means of attachment engaging the wall of this orifice, and

the additional means comprises a collar linked fixedly to the cylinder head and a nut screwed onto a screw thread of the collar, the nut keeping the sensor and a shoulder of the functional member pressed axially between it and a shoulder of the collar,

and/or the additional means comprises a collar structurally independent of the cylinder head, the collar having a first region for mechanical attachment intended to enter the orifice and comprising first attachment means suited to engaging with second attachment means formed in the wall of the orifice in the cylinder head, so as to attach the collar to this, cylinder head, in the orifice, and a second region of attachment located some distance from the orifice and having third means of attachment for a mechanical link between the functional member and the collar,

and the additional means also comprises a pressing and attachment member comprising fourth means of attachment designed to engage with the third means of attachment, so as to exert axial pressure on the sensor independently of the combustion pressure and so as to mechanically link the functional member to the collar, part of the exterior periphery of this functional member intended to come immediately to face the wall of the orifice in the cylinder head being mounted freely inside this orifice, having no means of attachment engaging with the wall of this orifice.

To make the functional member and the sensor easier to fit while at the same time protecting the latter and ensuring both effective retention of the functional member and reliable pressurizing of the sensor, along the axis of the orifice, it is also advisable:

that the exterior periphery of the functional member locally have a shoulder defining said part linked to the functional member against which the sensor is pressed by way of the bearing surface,

and/or that the collar comprise a hollow cylindrical component having a first part of a first diameter to be placed inside the orifice and a second part of a second diameter located outside the orifice, axially at the opposite end to the combustion chamber, this second diameter being greater than the first diameter, the second part thus having an interior volume designed to accommodate a shoulder of the functional member and the sensor which has an annular shape locally surrounding an exterior surface of the functional member.

In another case, in order to achieve the aforementioned objectives, it is advisable:

that the additional means comprise a collar fixed to the cylinder head outside the orifice, the collar locally defining said bearing surface fixed in terms of position with respect to the cylinder head,

that part of the exterior periphery of the functional member which part is intended to come immediately to face the wall of the orifice in the cylinder head be mounted freely inside this orifice, having no means of attachment engaging with the wall of this orifice, and

that the sensor be interposed between said bearing surface of the collar and a shoulder linked fixedly to the functional member, so that the displacement of the functional member with respect to the cylinder head under the effect of the pressure in the combustion chamber causes a variation in pressure on the sensor.

A more detailed description of the invention will now be given with reference to the attached drawings in which:

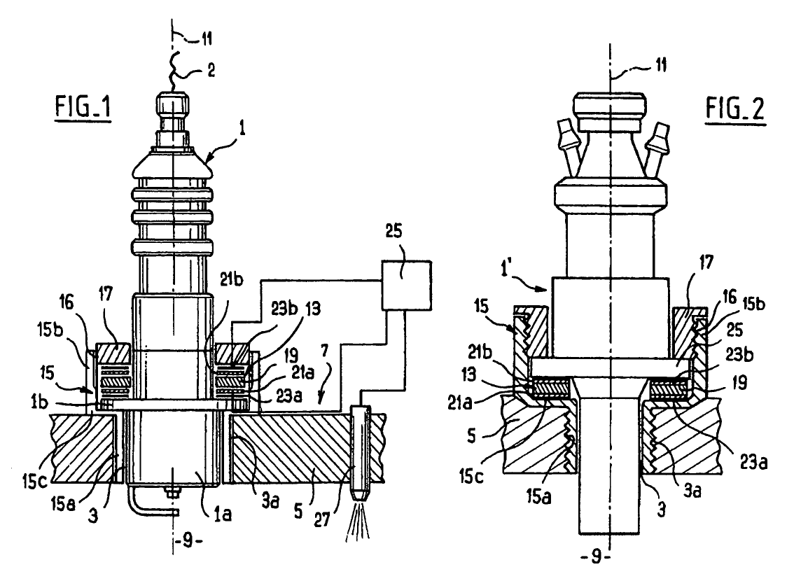

FIG. 1 shows a spark plug mounted axially floating in the orifice of a cylinder head in order to act on a pressure sensor or displacement transducer,

FIG. 2 shows a fuel injector mounted slightly differently in an orifice in the cylinder head,

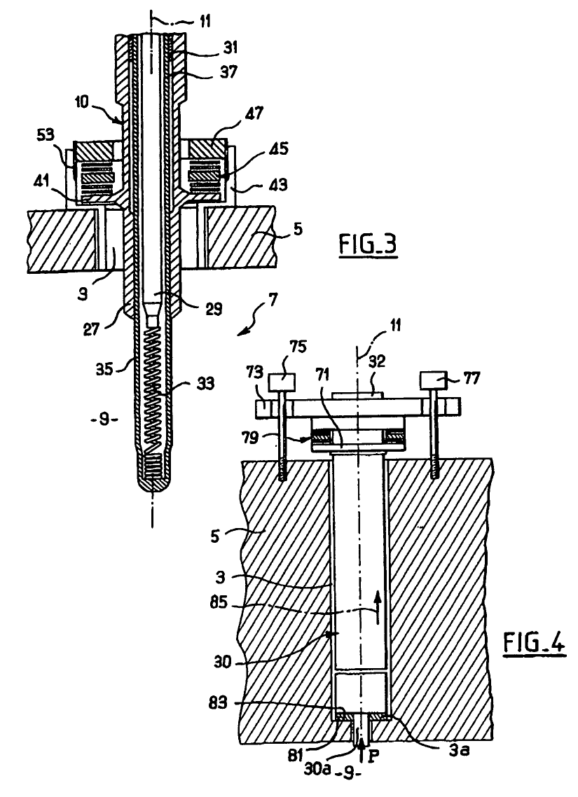

FIG. 3 shows a glow plug mounted on the cylinder head,

FIG. 4 shows, in an enlarged view, the mounting of a fuel injector on the cylinder head.

FIG. 1 shows a spark plug 1 powered electrically at 2 and mounted towards its base in a tapped orifice 3 in the cylinder head 5 of an internal combustion engine block 7 comprising a combustion chamber 9. The plug extends along an axis of elongation 11 coaxial with the orifice.

The head 1a of the plug 1 passes through the orifice and comprises an end with electrodes which communicates with the combustion chamber 9 and is therefore subjected to the pressure therein.

The pressure in the chamber 9 is recorded by way of a piezoelectric sensor 13.

In order to attach the plug with respect to the cylinder head 5 and pressurize the sensor 13, a collar 15 and a nut 17 have been provided.

The collar is in the form of a hollow cylindrical component having a threaded first part 15a engaged in the tapping 3a of the orifice 3 and a second part 15b of larger diameter located outside the orifice, axially at the opposite end to the combustion chamber. The parts 15a and 15b are connected by a shoulder 15c that rests against the cylinder head 5.

The second part 15b thus defines an interior volume designed to accommodate a shoulder 1b of the plug and the sensor 13, which is in annular shape, locally surrounding an exterior surface of the plug.

The nut (or threaded ring) 17 is screwed into a tapping 16 of the second part 15b.

The displacement transducer (or pressure sensor) comprises a sensitive element 19 made of piezoelectric material (ceramic) intercalated between two conductive contact rings 21a, 21b and electrically insulated from the shoulder 1b and from the nut 17 by way of insulating rings 23a, 23b.

Thus, once the collar 15 is fixedly attached to the cylinder head 5 (in this instance screwed into the orifice 3), and the plug 1 is mounted in the collar, with the sensor 13 subjected to the pressure of the nut 17, the plug is retained with respect to the cylinder head. Furthermore, any displacement of the plug 1 (along the axis 11) caused by the pressure variations in the combustion chamber 9 is detected by the piezoelectric element of the sensor 13.

For the detection of these pressure variations to improve the operation of the engine, the conducting rings of the sensor may be connected to an electronic computer 25 managing the operation of an injector 27.

The computer may thus measure the difference in voltage between the conducting rings, and from this deduce the amount of fuel to be injected into the combustion chamber, and the timing of the injection.

More specifically, during internal combustion, the pressure in the combustion chamber 9 increases and the spark plug 1 is subjected to this. As the plug is not screwed into the orifice 3, this pressure has a tendency to displace it more or less along the axis 11, towards the outside of the chamber 9, correspondingly compressing the sensor 13 between the shoulder 1b and the nut 17. The change in pressure exerted on the piezoelectric element 19 generates a potential difference between the contact rings 21a, 21b. This information is processed by the computer 25 which determines the injection conditions, particularly with reference to an operating model saved in memory, which may make it possible to take account of the state of the engine, whatever its operating history.

FIG. 2 shows a fuel injector 1′ freely mounted, along the axis 11, in the orifice 3 of the cylinder head 5 of an automobile engine, by way of a collar 15 screwed at 15a into the tapping 3a of the orifice 3; the pressing and attachment means 17 engaged with the widened rear part of the collar 15 pressurizes the displacement transducer 13.

In order not to clutter the drawings, the supply to the injector 1′, at the rear, at the opposite end to the combustion chamber 9, has not been shown.

In this version, the displacement transducer 13 is interposed between a peripheral radial shoulder 25 of the injector 1′ and a shoulder 15c of the collar 15.

As in FIG. 1, the shoulder 15c of the collar is radial to the axis of mounting 11, once all the elements of the device have been mounted on the cylinder head and are located between the parts 15a, 15b of the collar.

Also as in FIG. 1, the larger-diameter interior volume of the part 15b of the collar located outside the orifice 3 is sufficient to accommodate the part of the body of the injector that has the shoulder 25, and the annular sensor 13 then located around this body.

In this version, the sensor 13 is interposed between the shoulders 15 and 25, these two members being subjected to the axial pressure of the pressing and attachment means 17 which once again consists of a nut engaging with the tapping 16 of the outer part 15b of the collar.

The way in which the embodiment illustrated in FIG. 2 works is the same as the one illustrated in FIG. 1.

FIG. 3 shows a glow plug 10 mounted freely inside the orifice 3 of a cylinder head 5.

The plug 10 may be a glow plug of a diesel engine, running in the direction of elongation 11. The plug comprises an outer body 27, a central core 29 extending into the body, and an insulating ring 31 arranged between the body and the core, generally consisting of a seal made of an elastomeric material.

The core comprises an electrical resistive element 33 protected by a sheath 35 extending all the way into the combustion chamber 9, and a rod 29 integral with the sheath 35 and connecting the resistive element 33 to a current supply (not shown) to which the electrical current supply of the resistive element is connected.

At the rear of the cylinder head 5, that is to say at the opposite end to the combustion chamber 9, the exterior body 27 of the plug 10 has a radially protruding shoulder 41.

Furthermore, just like in the preceding figures, a collar or flange 43 is linked fixedly to the cylinder head 5 for the mounting and operation of a displacement transducer 45 (annular, identical to the sensor 13), linked with the plug and its shoulder 41, under the pressure and retention afforded by the rear pressing and attaching means 47 which once again consists in a nut engaged in the rear tapping 53 of the part of the collar 43 located outside the orifice 3, at the opposite end to the combustion chamber 9.

Unlike the teachings of EP-A-1 096 141, it is not, however, the slight axial displacement that may arise between the core 29 and the body 27 during the running of the engine that is used here to cause the pressure exerted on the sensor 45 to vary, but the displacement (typically of a few microns) of the entire plug 10, according to the pressure in the combustion chamber.

Thus, as in the case of the two previous embodiments, according to the pressure in the combustion chamber, the axial displacement of the shoulder 41 will cause the pressure on the sensor 45 to vary, the opposing pressure being provided by the nut 47, fixed in terms of position, engaged with the collar 43 itself fixed with respect to the cylinder head 5.

Of course, the set-up in FIG. 1, with the computer 25 and the injector 27 may be reproduced in FIG. 3, or in FIG. 2, provided that the sensor concerned can be built with the same annular components as the sensor 13.

FIG. 4 shows the application of the invention to an injector 30 (otherwise termed “fuel injection means”).

It will be noted that the injection nozzle 30a opens into the combustion chamber 9 and that the injector is mounted inside the orifice 3 in the cylinder head 5 without being directly fixed thereto, that is to say that, as in the versions of FIGS. 1, 2 and 3, the part of the exterior periphery of the functional member that comes immediately to face the wall of the orifice 3 is mounted freely inside this orifice, having no means of attachment engaging with the wall of this orifice.

In order not to clutter the drawings, the supply to the injector 30, at the rear, at the opposite end to the combustion chamber 9, has not been shown.

On the same side, it is nonetheless noted that the injector has a shoulder 71 radial to the axis of mounting 11 (which is still the axis of the orifice 3).

Still on the same side, a collar 73 extending perpendicular to the axis 11 is fixed to the cylinder head 5 by screws 75 and 77.

The rear end 32 of the injector 30 may pass through an opening made for that purpose in the collar 73, which opening will allow the pressure sensor/displacement transducer 79 interposed between the collar 73 and the shoulder 71 to be pressurized axially while the injector 30 is pressed axially against a shoulder 3a of the orifice 3, by way of a spacer piece 81, at the site where the injector 30 has a shoulder 83.

Thus, under the effect of the pressure P in the chamber 9, the injector 30 has a tendency to be pushed back in the direction of the arrow 85, and this exerts additional pressure on the sensor 79, which transmits this information in the way already indicated with reference to FIG. 1, it being possible for the computer 25, if necessary, to act on the injector 30 in return in order to tailor its operation to the response transmitted by the sensor.

Once again, it is noted that the pressure sensor/displacement transducer 79 in this instance is annular, being arranged around a part of the body of the injector 30.

If necessary, in the various versions, the sensor may be screwed around the relevant part of the functional member adopted.

1. A device for detecting the pressure in a combustion chamber of an internal combustion engine, comprising:
a functional member (1, 10, 30) used in the operation of the engine, the functional member passing through the wall of a cylinder head (5) inside an orifice (3) having an axis (11) and formed in this wall, the functional member communicating via this orifice with a combustion chamber (9) of the engine and being intended to be mechanically linked to the cylinder head, with this functional member being able to move axially with respect to the cylinder head under the effect of the pressure in the combustion chamber,
and a sensor (19, 45, 79) sensing the combustion pressure in this chamber, the sensor being axially pressed against a part (1b, 25, 41) linked to the functional member, via a bearing surface (17, 47, 73) fixed in terms of position with respect to the cylinder head, independently of the pressure in the combustion chamber, so that the sensor detects the displacement of the functional member upon variations in the pressure in the combustion chamber,
characterized in that:
a mechanical link between the functional member (1, 10, 30) and the cylinder head (5) is achieved by way of an additional means (15, 17, 43, 47, 73) linked fixedly to this cylinder head,
and at least part (17, 47, 73) of this additional means exerts pressure on the sensor (19, 45, 79) thereby defining said bearing surface that is fixed in terms of position with respect to the cylinder head when the functional member which is mounted on the cylinder head (5) is in an operational state ready to be subjected to the pressure in the combustion chamber.

2. The device as claimed in claim 1, characterized in that:
part (1a) of the exterior periphery of the functional member intended to come immediately to face the wall of the orifice in the cylinder head (5) is mounted freely inside this orifice (3), having no means of attachment engaging the wall of this orifice, and
the additional means comprises a collar (15, 43) linked fixedly to the cylinder head and a nut (17, 47) screwed onto a screw thread of the collar, the nut keeping the sensor and a shoulder (1b, 25, 41) of the functional member pressed axially between it and a shoulder (15c) of the collar.

3. The device as claimed in claim 1, characterized in that the additional means comprises:
a collar (15, 45) structurally independent of the cylinder head, the collar having a first region (15a) for mechanical attachment intended to enter the orifice (3) and comprising first attachment means suited to engaging with second attachment means (3a) formed in the wall of the orifice (3) in the cylinder head, so as to attach the collar to this cylinder head, in the orifice, and a second region of attachment (16) located some distance from the orifice and having third means of attachment for a mechanical link between the functional member (1, 10) and the collar,
and a pressing and attachment member (17, 47) comprising fourth means of attachment designed to engage with the third means of attachment, so as to exert axial pressure on the sensor (13, 45) independently of the combustion pressure and so as to mechanically link the functional member to the collar, part (1a) of the exterior periphery of this functional member intended to come immediately to face the wall of the orifice (3) in the cylinder head being mounted freely inside this orifice, having no means of attachment engaging with the wall of this orifice.

4. The device as claimed in claim 3, characterized in that:
the exterior periphery of the functional member locally has a shoulder (1b, 25, 41) defining said part linked to the functional member, and
the sensor (13, 45) is interposed between a shoulder (15c) of the collar and the attachment and pressing member (17, 47).

5. The device in claim 2, characterized in that the collar comprises a hollow cylindrical component having a first part (15a) of a first diameter to be placed inside the orifice and a second part (15b) of a second diameter located outside the orifice, axially at the opposite end to the combustion chamber (9), this second diameter being greater than the first diameter, the second part thus having an interior volume designed to accommodate the shoulder of the functional member (1, 10) and the sensor (13, 45) which has an annular shape locally surrounding an exterior surface of the functional member.

6. The device as claimed in claim 1, characterized in that:
the additional means comprises a collar (73) fixed to the cylinder head outside the orifice, the collar locally defining said bearing surface fixed in terms of position with respect to the cylinder head,
part of the exterior periphery of the functional member (30) which part is intended to come immediately to face the wall of the orifice (3) in the cylinder head is mounted freely inside this orifice, having no means of attachment engaging with the wall of this orifice, and
the sensor (79) is interposed between said bearing surface of the collar and a shoulder (71) linked fixedly to the functional member, so that the displacement of the functional member with respect to the cylinder head under the effect of the pressure in the combustion chamber causes a variation in pressure on the sensor.

7. The device in claim 4, characterized in that the collar comprises a hollow cylindrical component having a first part (15a) of a first diameter to be placed inside the orifice and a second part (15b) of a second diameter located outside the orifice, axially at the opposite end to the combustion chamber (9), this second diameter being greater than the first diameter, the second part thus having an interior volume designed to accommodate the shoulder of the functional member (1, 10) and the sensor (13, 45) which has an annular shape locally surrounding an exterior surface of the functional member.
